(19) United States
(12) Patent Application Publication
(10) Pub. No.: US 2025/0285203 A1
(43) Pub. Date: Sep. 11, 2025

(54) Vehicle Dispatching System, Method of Processing Information, and Non-Transitory Computer-Readable Storage Medium

(71) Applicant: YAMAHA CORPORATION, Hamamatsu-shi (JP)

(72) Inventors: Keita ARIMOTO, Hamamatsu-shi (JP); Keijiro SAINO, Hamamatsu-shi (JP); Futoshi SHIRAKIHARA, Hamamatsu-shi (JP); Yu TAKAHASHI, Hamamatsu-shi (JP); Tomoya MIYATA, Hamamatsu-shi (JP)

(21) Appl. No.: 18/893,221

(22) Filed: Sep. 23, 2024

Related U.S. Application Data
(63) Continuation of application No. PCT/JP2023/009368, filed on Mar. 10, 2023.

(30) Foreign Application Priority Data
Mar. 24, 2022 (JP) 2022-048119

(51) Int. Cl. G06Q 50/47; G01C 21/34; G06Q 30/0283; H04R 3/00

(52) U.S. Cl. CPC G06Q 50/47; G01C 21/3415; G06Q 30/0283; H04R 3/002; G06Q 2240/00; H04R 2499/13

(57) ABSTRACT

A vehicle dispatching system includes a first obtainer, a second obtainer, a determiner, and a vehicle dispatching instructor. The first obtainer obtains status information including a first sound condition employed in a sound space provided in a vehicle. The second obtainer obtains request information transmitted from a terminal device of a first user. The request information includes a desired sound condition that the first user wishes to be realized in the sound space in the vehicle. The determiner makes a determination, based on the status information and the request information, as to whether to allow the first user to board the vehicle. The vehicle dispatching instructor dispatches the vehicle based on a result of the determination made by the determiner.

### CROSS-REFERENCE TO RELATED APPLICATIONS

The present application is a continuation application of International Application No. PCT/JP2023/009368, filed Mar. 10, 2023, which claims priority to Japanese Patent Application No. 2022-048119, filed Mar. 24, 2022. The contents of these applications are incorporated herein by reference in their entirety.

### BACKGROUND

The present disclosure relates to a vehicle dispatching system, a method of processing information, and a non-transitory computer-readable storage medium. Performers may occasionally take measures to limit the extent to which sound

from their performance travels to the surrounding area. For example, JP2020-204253A discloses a soundproof room in which a performer performs to ensure that no sound escapes to the outside. For another example, a performer may perform in a soundproof environment such as within a music studio.

However, using a soundproof facility requires the performer to travel to the site, which involves both time and effort.

The present disclosure has been made in view of the above-described and other circumstances, and has an object to provide a vehicle dispatching system that reduces the time and effort required to move to a desired sound space. The present disclosure also has an object to provide a method of processing information that reduces the time and effort required to move to a desired sound space. The present disclosure also has an object to provide a non-transitory computer-readable storage medium that reduces the time and effort required to move to a desired sound space.

### SUMMARY

One aspect is a vehicle dispatching system that includes a first obtainer, a second obtainer, a determiner, and a vehicle dispatching instructor. The first obtainer is configured to obtain status information including a first sound condition employed in a sound space provided in a vehicle. The second obtainer is configured to obtain request information transmitted from a terminal device of a first user. The request information includes a desired sound condition that the first user wishes to be realized in the sound space in the vehicle. The determiner is configured to make a determination, based on the status information and the request information, as to whether to allow the first user to board the vehicle. The vehicle dispatching instructor is configured to dispatch the vehicle based on a result of the determination made by the determiner.

Another aspect is a computer-implemented method of processing information. The method includes obtaining status information including a sound condition employed in a sound space provided in a vehicle. The method also includes obtaining request information transmitted from a terminal device of a user. The request information indicates a desired sound condition that the user wishes to be realized in the sound space in the vehicle. The method also includes, based on the status information and the request information, making a determination as to whether to allow the user to board the vehicle. The method also includes dispatching the vehicle based on a result of the determination.

Another aspect is a computer-implemented method of processing information. The method includes obtaining, from a vehicle dispatcher, pieces of vehicle information each including a profile of a passenger who boards a vehicle including a performance space and who uses the performance space. The method also includes performing first processing of displaying the pieces of vehicle information on a display. The method also includes obtaining an instruction specifying a vehicle to be used from a user selecting a piece of vehicle information from among the pieces of vehicle information. The method also includes transmitting, to the vehicle dispatcher, specifying information corresponding to the obtained instruction. The method also includes receiving, from the vehicle dispatcher, information indicating whether the vehicle specified by the specifying information is available.

Another aspect is a non-transitory computer-readable storage medium storing a program. When the program is executed by at least one processor, the program causes the at least one processor to obtain, from a vehicle dispatcher, pieces of vehicle information each including a profile of a passenger who boards a vehicle including a performance space and who uses the performance space. The program also causes the at least one processor to perform first processing of displaying the pieces of vehicle information on a display. The program also causes the at least one processor to obtain an instruction specifying a vehicle to be used from a user selecting a piece of vehicle information from among the pieces of vehicle information. The program also causes the at least one processor to transmit, to the vehicle dispatcher, specifying information corresponding to the obtained instruction. The program also causes the at least one processor to receive, from the vehicle dispatcher, information indicating whether the vehicle specified by the specifying information is available.

A more complete appreciation of the present disclosure and many of the attendant advantages thereof will be readily obtained as the same becomes better understood by reference to the following detailed description when considered in connection with the following figures.

### BRIEF DESCRIPTION OF THE DRAWINGS

FIG. 1 is a perspective view of a vehicle V according to an embodiment;

FIG. 2 is a schematic illustration of a system configuration of a vehicle dispatching system S;

FIG. 3 is a conceptual illustration of a flow of how to use the vehicle dispatching system S;

FIG. 4 is a functional block diagram illustrating a configuration of a vehicle dispatching server 30;

FIG. 5 is a schematic illustration of an example of user information;

FIG. 6 is a schematic illustration of an example of dispatched member data including evaluation data;

FIG. 7 is a schematic illustration of an example of map data stored in a map storage 310;

FIG. 8 is a functional block diagram illustrating functions of a distribution server 40;

FIG. 9 is a flowchart describing operations of the vehicle dispatching system S;

FIG. 10 is a flowchart describing operations of the vehicle dispatching system S;

FIG. 11 is a flowchart describing additional processing of allowing users to board the vehicle V; and

FIG. 12 is a flowchart describing a live distribution.

### DESCRIPTION OF THE EMBODIMENTS

The present specification is applicable to a vehicle dispatching system, a method of processing information, and a non-transitory computer-readable storage medium.

The vehicle dispatching system S according to an embodiment will be described by referring to the accompanying drawings.

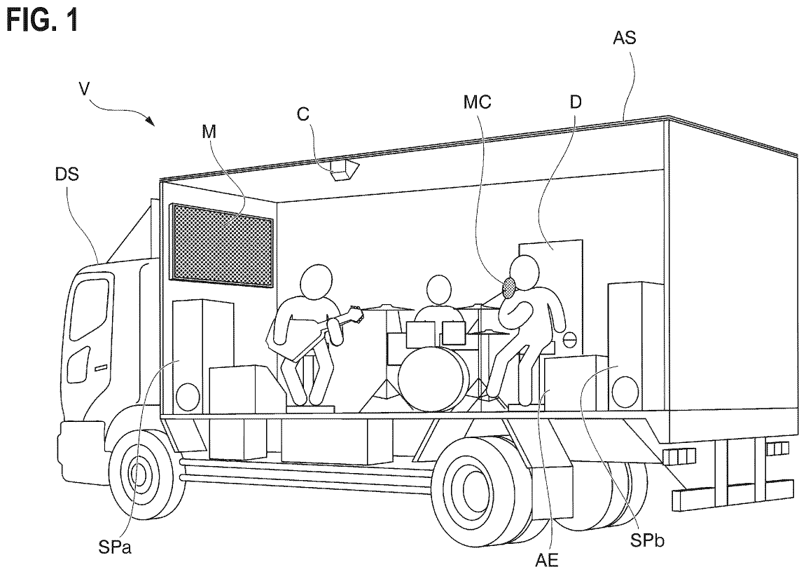

FIG. 1 is a perspective view of the vehicle V according to the embodiment.

The vehicle V has a sound space AS behind a driver's seat DS. The vehicle V may be driven by automatic driving or by a driver in the driver's seat DS. In FIG. 1, a view of the vehicle Vis illustrated as if looking through the sound space AS from its left side.

The sound space AS is a soundproof room that minimizes the transmission of sound produced at the inside of the sound space AS to the outside of the sound space AS. Due to the soundproof nature of the sound space AS, even if a user of the sound space AS produces sound at the inside of the sound space AS, the sound is prevented from spreading to the surrounding area. This reduces the burden on the user to prevent sound from spreading to the surrounding area.

In the sound space AS, at least one piece of equipment is provided. Examples of the at least one piece of equipment include: a studio facility in which musical instruments can be played; karaoke equipment; and theater equipment.

In a case that a studio facility is provided in the sound space AS, the user of the sound space AS is able to perform using the studio facility. In a case that the user plays a musical instrument in the sound space AS, the sound space AS may occasionally be referred to as performance space.

In a case that karaoke equipment is provided in the sound space AS, the user of the sound space AS is able to sing using the karaoke equipment. In a case that theater equipment is provided in the sound space AS, the user of the sound space AS is able to enjoy activities such as watching movies, listening to music, and viewing sports events. In a case that the user enjoys watching movies, listening to music, or viewing sports events in the sound space AS, the user is able to enjoy sound without playing a musical instrument. There may be a case that the user applauses or makes other noises while enjoying these activities. Even in this case, the design of the sound space AS minimizes the transmission of the sound to the outside.

FIG. 1 illustrates a case that a studio facility for musical performances is provided in the sound space AS. In this case, the vehicle V can function as a studio vehicle. The inner circumference or the outer circumference of the sound space AS is surrounded by soundproof material. The sound space AS includes a display M, an audio equipment AE, a speaker SPa, a speaker SPb, a camera C, a microphone MC, and a door D.

The display M is mounted on a wall surface on the inner circumference of the sound space AS, and displays various images. In this specification, the term “image” is intended to encompass a still image, a sequence of still images, multiple still images spaced throughout time, or images in the form of a video. In the sound space AS, the user is able to visually recognize a display screen of the display M.

The camera C captures images of the inside of the sound space AS.

The microphone MC collects sound produced at the inside of the sound space AS. For example, in a case that the microphone MC is used by a vocalist, the microphone MC collects the voice of the vocalist. In a case that the microphone MC is provided near a musical instrument, the microphone MC is able to collect sound emitted from the musical instrument.

The audio equipment AE is connected to the microphone MC, the speaker SPa, and the speaker SPb via cables. The audio equipment AE may also be connected to, via a cable, a musical instrument capable of outputting a sound signal. Examples of the musical instrument capable of outputting a sound signal included an electric guitar and an electronic instrument. The audio equipment AE is communicably connected to a vehicle terminal 20.

The audio equipment AE receives at least one sound signal, namely, a sound signal input from the microphone MC or a sound signal input from the musical instrument played by the user in the sound space AS. Then, the audio equipment AE outputs the input sound signal to the speaker SPa and the speaker SPb. The sound signal input into the audio equipment AE may be an analogue signal or a digital signal.

The speaker SPa and the speaker SPb each include a built-in amplifier to amplify the sound signal output from the audio equipment AE so that the speaker SPa and the speaker SPb each emit the amplified sound signal.

The door D may be provided at any position in the sound space AS. By opening the door D, the user is able to enter the sound space AS or exit the sound space AS. In FIG. 1, the door D is positioned on the right side of the sound space AS in the direction of travel of the vehicle V. The door D is also made of soundproof material. By closing the door D, a leakage of the sound produced in the sound space AS through the door D is minimized.

The sound space AS can accommodate at least one user. FIG. 1 illustrates a case that the sound space AS accommodates three users. Specifically, the sound space AS accommodates a band consisting of three members, a vocalist, a guitarist, and a drummer.

In the sound space AS, the user is able to perform regardless of whether the vehicle V is traveling or stationary.

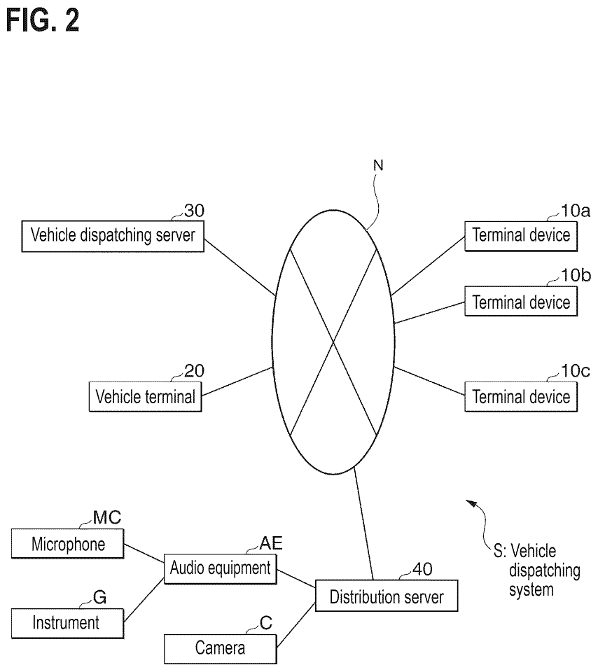

FIG. 2 is a schematic illustration of a system configuration of the vehicle dispatching system S.

The vehicle dispatching system S includes a terminal device 10a, a terminal device 10b, a terminal device 10c, the vehicle terminal 20, the vehicle dispatching server 30, and the distribution server 40. These elements are communicatively connected to each other via a network N. The terminal device 10a, the terminal device 10b, and the terminal device 10c will be collectively referred to as terminal device 10 where it is not necessary to distinguish the terminal devices 10a, 10b, and 10c from each other. To the distribution server 40, the camera C and the audio equipment AE are connected. To the audio equipment AE, the microphone MC and a musical instrument G are connected.

The terminal device 10 is communicatively connected to the vehicle terminal 20, the vehicle dispatching server 30, and the distribution server 40 via the network N. The terminal device 10 includes a display, in addition to various input devices such as a mouse, a keyboard, and a touch panel. The terminal device 10 may include a camera and a microphone.

The terminal device 10 may be any one of a smartphone, a tablet, and a computer. The terminal device 10 is used by a user of the vehicle dispatching system S.

The vehicle terminal 20 is incorporated in the vehicle V. The vehicle terminal 20 is communicatively connected to the vehicle dispatching system S, the terminal device 10, and the distribution server 40 via the network N. The vehicle terminal 20 is also connected to the camera C via a video cable to obtain image data captured by the camera C and transmit the image data to the distribution server 40.

The vehicle terminal 20 is also connected to the display M via an image cable to supply an image signal to the display M so that the display M displays the image signal. The vehicle terminal 20 is also connected to the audio equipment AE via a sound cable to supply a sound signal to the sound cable.

The vehicle terminal 20 is incorporated in the vehicle V.

While in FIG. 2 a single vehicle terminal 20 is provided, there may be a case that a plurality of vehicles V are provided, in which case a plurality of vehicle terminals 20 are provided respectively corresponding to the plurality of vehicles V.

The vehicle dispatching server 30 is communicatively connected to the terminal device 10, the vehicle terminal 20, and the distribution server 40 via the network N.

The camera C has a function to communicate with the distribution server 40, and for this function, is connected to the distribution server 40 via an image cable. In a case that the camera C does not have a function to communicate with the distribution server 40, the camera C may be communicatively connected to the distribution server 40 via a computer or other intermediary device.

The audio equipment AE is communicatively connected to the microphone MC and the musical instrument G. The audio equipment AE has a function to communicate with the distribution server 40, and for this function, is wirelessly connected to the distribution server 40. In a case that the audio equipment AE does not have a function to communicate with the distribution server 40, the audio equipment AE may be communicatively connected to the distribution server 40 via a computer or other intermediary device.

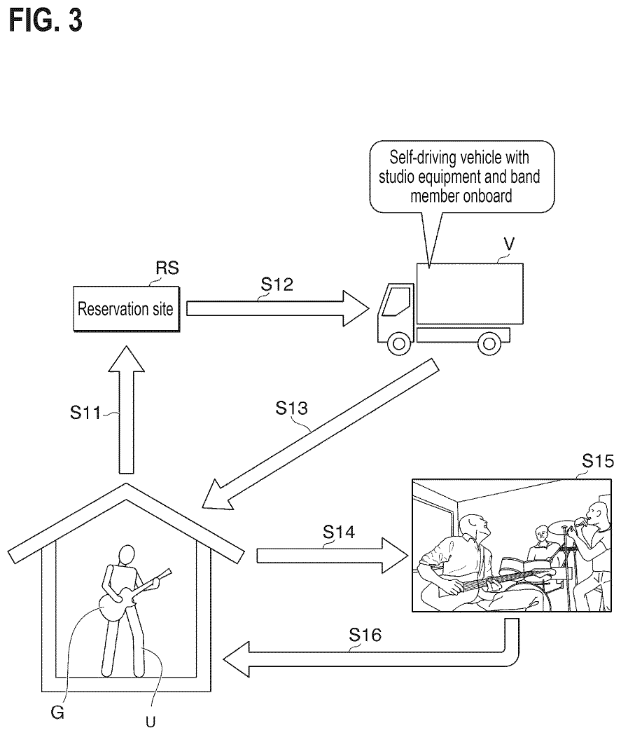

FIG. 3 is a conceptual illustration of a flow of how to use the vehicle dispatching system S.

When a user U uses a vehicle dispatching service provided by the vehicle dispatching system S, the user U inputs request information into the user U′s terminal device 10 (for example, the terminal device 10a). The terminal device 10 transmits the request information to a reservation site RS (step S11). The request information is regarding usage of the vehicle dispatching service. More specifically, the request information indicates details of an order for using the sound space AS of the vehicle V.

The request information transmitted to the reservation site RS includes information indicating a sound condition that the user U desires to be realized in the sound space AS. The request information may also include a time period for using the sound space AS (usage start date and time and usage end date and time) and a boarding place indicating a place to board the vehicle V.

As used in the present disclosure, the term sound condition is intended to mean a condition in which sound is produced in the sound space AS. The sound condition includes at least one of a performance condition or a usage condition. The performance condition indicates a condition in which a musical performance is performed in the sound space AS. The usage condition indicates a condition in which sound is produced without a musical performance.

The performance condition may be at least one of the following conditions: type of musical instrument played by the user; a song scheduled to be played; genre of a song scheduled to be played; whether dispatched members will also be onboard to perform (such as in a session) in the sound space AS; whether it is possible to share the ride and accommodate other users (performers) in the vehicle V; desired band configuration; use of the sound space AS as a music classroom for lessons; and use of the sound space AS for karaoke.

In a case that the performance condition indicates that the sound space AS is used by a plurality of users, the members sharing the sound space AS may be members pre-summoned by the user U or may be dispatched members provided along with the rental of the vehicle V as part of the vehicle dispatching service.

In a case that the user U performs with members pre-summoned by the user U, the members may be acquaintances, friends, family members, individuals from the same school, or individuals from the same workplace. In a case that the user U performs with dispatched members, it is not necessary for the user U to pre-summon members to perform with, since the members can be dispatched for the performance.

The usage condition may indicate an activity using the theater equipment, such as watching a movie and listening to music, or may indicate an activity using the monitor or screen, such as viewing a sports event. In a case of watching a movie or listening to music, the use of the theater equipment ensures that the user U can enjoy the activity with enhanced sound at higher volumes. In a case of viewing a sports event, loud cheering may occur. The usage condition may indicate that the user U uses the sound space AS alone or a plurality of users use the sound space AS.

The reservation site RS is a public website managed by the vehicle dispatching server 30. The vehicle dispatching server 30 receives request information via the reservation site RS. The vehicle dispatching server 30 performs vehicle dispatching by assigning a vehicle V based on the performance condition included in the request information (step S12). For example, the vehicle dispatching server 30 assigns a vehicle V provided with the equipment necessary for playing a musical instrument, such as the audio equipment AE, the speaker SPa, and the speaker SPb, as indicated by the performance condition. In a case that the performance condition indicates karaoke, the vehicle dispatching server 30 assigns a vehicle V provided with the equipment necessary for karaoke, such as the karaoke equipment, the audio equipment AE, the speaker SPa, and the speaker SPb. In a case that the performance condition indicates that the user U performs with a dispatched member, the vehicle dispatching server 30 transmits a notification to the dispatched member's terminal device 10 (for example, the terminal device 10c). The notification indicates that the dispatched member has been summoned and identifies the vehicle V to which the dispatched member is assigned.

In a case that the usage condition indicates an activity using the theater equipment, the vehicle dispatching server 30 assigns a vehicle V provided with the theater equipment. By assigning the vehicle V to the user U, the user U is able to rent the sound space AS and use the sound space AS. By renting the sound space AS, the user U is able to arrange for the vehicle V to pick up the user U at a place desired by the user U.

The vehicle V assigned to the user U by the vehicle dispatching server 30 based on the request information travels to the place specified by the user U to pick up the user U (step S13). The place specified by the user U may be the current location of the user U (such as home, workplace, and school). In the vehicle dispatching service, the vehicle V may be driven by a driver of the vehicle V or may be automatically driven in a case that the vehicle V is a self-driving vehicle. In a case that a dispatched member is already summoned, the vehicle V travels to the place desired by the user U with the dispatched member located in the sound space AS.

The vehicle V travels to the place desired by the user U and picks up the user U at the place so that the user U can enter the sound space AS.

After the user U boards the vehicle V, the vehicle V travels along its travel path (step S14).

Upon boarding the vehicle V, the user U is able to use the sound space AS of the vehicle V based on the sound condition, such as playing the musical instrument G, doing karaoke, and doing an activity using the theater equipment (step S15). In this respect, the vehicle V comes the location of the user U to pick up the user U. In a case that the user U plays the musical instrument G, the user U is able to use a soundproof space, instead of going all the way to a music studio with the musical instrument G. This reduces the time and effort required of the user U to move to the desired sound space.

The user U is able to do a musical performance or activities such as watching movies, listening to music, and viewing sports events in the sound space AS even while the vehicle Vis traveling. For example, in a case that the sound condition indicates playing of a musical instrument, the user U is able to use the audio equipment AE of the traveling vehicle V to play the musical instrument or perform a session with the onboard members.

In a case that the vehicle V travels while the user U is using the audio equipment AE, the sound space AS, which can be referred to as sound source, moves. In a case that the user U performs at a fixed place (for example, the user U's home), the position of the sound source remains unchanged, causing the sound of the performance to be continuously transmitted to individuals located around the sound source. This potentially causes an impact on these individuals. In contrast, in the embodiment of the present disclosure, the vehicle V travels, thus changing the position of the sound source. This ensures that the position of the sound source changes relatively for individuals located outside the vehicle V, preventing the sound of the performance to be continuously transmitted to individuals located outside the vehicle V. As a result, the discomfort experienced by individuals located outside the vehicle V can be alleviated.

Also in the embodiment of the present disclosure, there is no need to install a soundproof room in the user U's home or similar locations. That is, the performance location can be moved to a place other than the home, and the sound source can be isolated in a location where the sound source will not cause a disturbance.

Additionally, the travel path of the vehicle V can be set to a travel path that avoids areas such as residential neighborhoods or locations with buildings. This ensures that the vehicle V travels through areas with fewer people outside, thereby reducing the impact on the surroundings.

As the usage end time approaches, the vehicle V travels to a place (for example, home, workplace, and school) set as an intended location (destination) by the user U (step S16). When the vehicle V reaches the destination, the user U exits the vehicle V.

It is to be noted that in this embodiment, in a case that the performance condition indicates playing of a musical instrument that can be played without audio equipment, the vehicle dispatching server 30 may assign a vehicle in which no audio equipment AE is incorporated. For example, acoustic instruments such as the piano, saxophone, and violin can be enjoyed without the need for audio equipment. In a case that the user U himself/herself brings a portable amplifier device in the sound space AS, the vehicle dispatching server 30 may assign a vehicle in which no audio equipment AE is incorporated.

This embodiment ensures that by renting the vehicle V, the user can have a studio environment delivered to the user's home.

Next, the vehicle dispatching system S will be described in more detail.

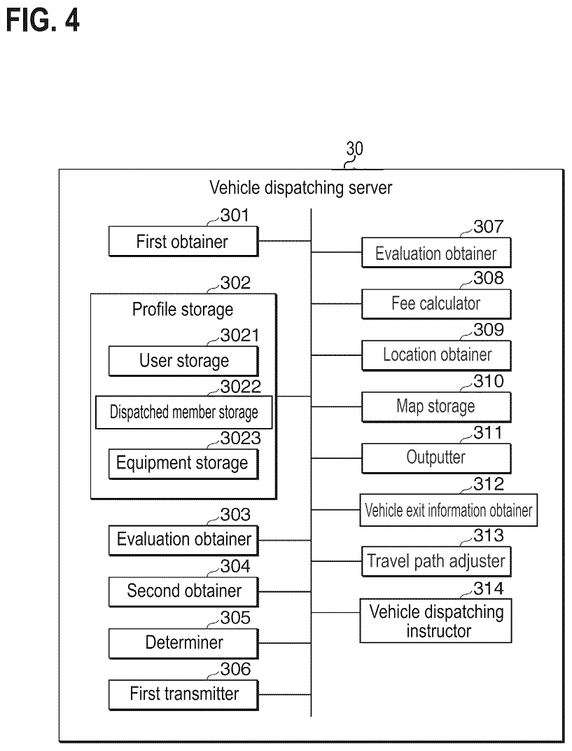

FIG. 4 is a functional block diagram illustrating a configuration of the vehicle dispatching server 30.

The vehicle dispatching server 30 includes a first obtainer 301, a profile storage 302, an evaluation obtainer 303, a second obtainer 304, a determiner 305, a first transmitter 306, an evaluation obtainer 307, a fee calculator 308, a location obtainer 309, the map storage 310, an outputter 311, a vehicle exit information obtainer 312, a travel path adjuster 313, and a vehicle dispatching instructor 314. The elements of the vehicle dispatching server 30 are connected to each other via a bus so that data can be exchanged between the elements.

The first obtainer 301 obtains status information including a sound condition employed in a sound space provided in a vehicle. For example, the first obtainer 301 retrieves information stored in at least one of an equipment storage 3023 or a dispatched member storage 3022, which will be described later. This information is regarded as the status information.

The status information may include information indicating pieces of equipment available in making a performance in the performance space. The information indicating pieces of equipment may be, for example, information indicating a type of audio equipment used in playing a musical instrument. The type of audio equipment may be at least one of guitar amplifier type, effector type, mixer type, live distribution equipment type, or karaoke equipment type.

The status information may also include information indicating musical instrument type (such as piano, electric piano, keyboard, and drum). In a case that the status information includes musical instrument type, the user is able to specify a vehicle carrying a type of musical instrument that the user wishes or to specify a musical instrument that the user wishes to play. This enables the user to select a vehicle equipped with a piece of equipment that most suits the user's objectives.

The status information may also include a profile of a dispatched member. The dispatched member is a member who is dispatched along with the rental of the vehicle to perform in the performance space. In this case, the user U is able to specify a vehicle carrying a type of dispatched member that the user U desires. This enables the user U to receive a service that dispatches a member to perform together with the user U when selecting a vehicle.

The status information may also include a profile of a boarding aspirant wishing to board the vehicle and ready to board the vehicle. In this case, the status information may be transmitted from a terminal device 10 (for example, the terminal device 10b) of a user different from the user U, who has requested to use the vehicle V. The boarding aspirant is not a dispatched member but an individual who is different from the user U and wishes to perform together with the user U. The boarding aspirant is a user who wishes to be an additional user to board a vehicle V currently used by one user.

The first obtainer 301 also obtains an equipment specification (sound condition) from the equipment storage 3023 of the profile storage 302.

The profile storage 302 stores various kinds of data.

The profile storage 302 includes a user storage 3021, the dispatched member storage 3022, and the equipment storage 3023.

The user storage 3021 stores user information regarding users of the vehicle V.

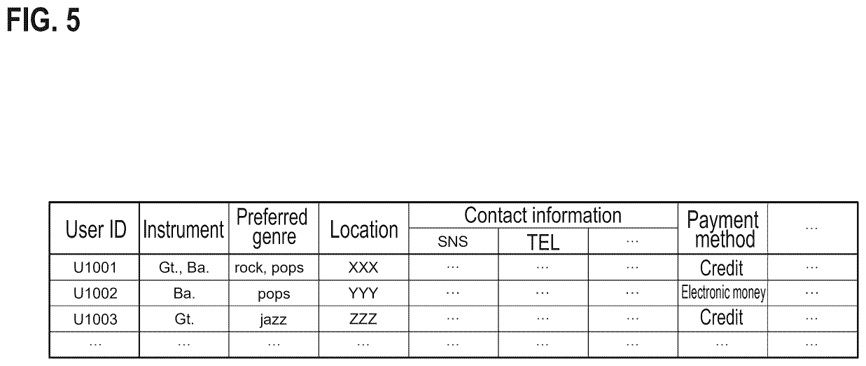

FIG. 5 is a schematic illustration of an example of the user information. The user information includes items such as User ID, Preferred musical instrument, Preferred genre, Location, Contact information, and Payment method.

User ID is identification information for identifying the user. Preferred musical instrument indicates a musical instrument that the user prefers to play. Preferred genre indicates a genre of music that the user prefers to play. Location indicates a primary place where the user conducts the user's activities. For example, Location may be home, school, or workplace. Contact information is the user's contact information. For example, Contact information may be a contact accessed via the terminal device 10.

Payment method indicates a payment method for compensating for the use of the vehicle V. Examples of Payment method include payments made by credit card and electronic money.

It is to be noted that the user information may include an evaluation value.

The dispatched member storage 3022 stores an evaluation of each dispatched member whom the user performed with in the sound space. For example, the dispatched member storage 3022 stores evaluation data in which an evaluation value is linked to a dispatched member.

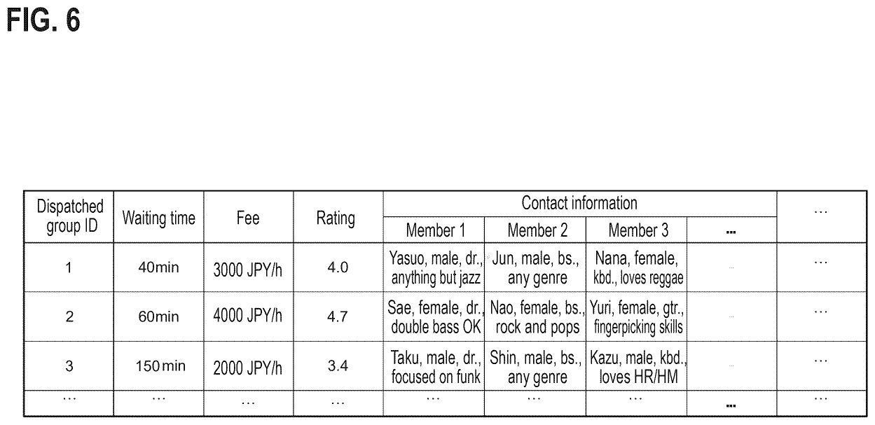

FIG. 6 is a schematic illustration of an example of the dispatched member data, including the evaluation data, of dispatched members targeted for evaluation.

The dispatched member data includes Dispatched group ID, Waiting time, Fee, Rating, and Contact information.

Dispatched group ID is an item for identifying a dispatched member group. The dispatched member group includes at least one dispatched member. For example, the user U may request a dispatched member group that includes three dispatched members who play different musical instruments to perform together in the vehicle V. In this case, the user U and the three dispatched members can form a four-configuration band to play a session.

Waiting time indicates the time before the dispatched member group is available.

Fee indicates a fee for using the dispatched member group. This fee may include a fee for using the vehicle V.

Rating indicates the evaluation value. In this example, a higher Rating value may indicate that the dispatched member group is more highly evaluated (or better evaluated). Alternatively, a lower Rating value may indicate that the dispatched member group is more highly evaluated. Rating may be a value assigned to the dispatched member group as an evaluation. Rating may also be determined by calculating the average of the individual ratings assigned to the dispatched members who belong to the dispatched member group.

Contact information includes each member's attributes. The member's attributes indicate attributes of each dispatched member who belongs to the dispatched member group. The attributes include the dispatched member's name, the dispatched member's gender, a musical instrument that the dispatched member can play, and a genre that the dispatched member can play.

More specifically, in the dispatched member group whose dispatched member group ID is 1, Waiting time is “40 min” (“min” is an abbreviation of “minutes”), Fee is “3000 JPY/h”, and Rating is “4.0”. The attributes of member 1 are “Yasuo, male, dr., anything but jazz”. The attributes of member 2 are “Jun, male, bs., any genre”. The attributes of member 3 are “Nana, female, kbd., Loves reggae”. By referring to the attributes of the members of each dispatched member group, the user is able to identify the types of musical instruments and the genres of music that the dispatched member group can accommodate. This enables the user to select a dispatched member group that suits the user's preferences.

The dispatched member groups include a female-only dispatched member group, which is made up of female dispatched members only. In a case of a female user, a female-only dispatched member group may be more comfortable for the user to use.

In a case that a dispatched member group includes a popular dispatched member, the dispatched member group is highly evaluated, being given a higher Rating value. There may be a case that a higher Fee is set for this dispatched member group in accordance with its Rating.

The equipment storage 3023 stores an equipment specification (sound condition) employed in each vehicle. For example, the equipment storage 3023 stores the type and specifications of the equipment incorporated in each of a plurality of vehicles V. More specifically, the equipment specification may be information indicating the type of audio equipment used in playing a musical instrument, or may be the number of people that the sound space AS can accommodate. Examples of the type of audio equipment include guitar amplifier type, effector type, mixer type, live distribution equipment type, and karaoke equipment type.

The evaluation obtainer 303 obtains, from the terminal device 10, evaluation values of a plurality of other users with which the user U shared the sound space AS. The plurality of other users may be dispatched members or additional onboard users. The evaluation obtainer 303 causes the profile storage 302 to store the obtained evaluation values of the plurality of respective other users.

The second obtainer 304 obtains request information transmitted from the user U's terminal device 10 (for example, the terminal device 10a). In requesting a vehicle V to be dispatched, the user U transmits, from its terminal device 10a, request information including a sound condition to the vehicle dispatching server 30. The request information includes information indicating a sound condition that the user U desires to be realized in the sound space AS. The request information may also include the time period for using the sound space AS (the usage start date and time and the usage end date and time) and a boarding place indicating a place to board the vehicle V.

For example, there may be a case that the user U is not aboard an undispatched vehicle V and requests this vehicle V to be dispatched. In this case, the second obtainer 304 obtains request information transmitted from the user U's terminal device 10a.

There also may be a case that a user is not aboard a moving vehicle V that is already being used (occupied) by another user and that the user wishes to board the vehicle V as an additional user. In this case, the second obtainer 304 obtains, from the user's terminal device 10 (for example, the terminal device 10b), request information indicating that the user wishes to board the vehicle V.

Upon receipt of the request information indicating the wish to board the vehicle V as an additional user, the second obtainer 304 obtains specifying information from the terminal device 10a of the user who is already on board. The specifying information specifies a boarding aspirant, among a plurality of boarding aspirants, who is allowed to board the vehicle V.

The determiner 305 determines whether to allow a user to enter the sound space AS of the vehicle V based on the request information and the status information. The request information is obtained from the terminal device 10 (for example, the terminal device 10a or the terminal device 10b). The status information is obtained by the first obtainer 301.

There are, for example, two ways to determine whether to allow entrance into the sound space AS. A first way of determination is to use request information transmitted from the terminal device 10a of a user who wishes to rent a vehicle V in determining whether to allow the user to use the sound space AS of the vehicle V. A second way of determination is to use request information transmitted from the terminal device 10b of another user in determining whether to allow the another user to use the sound space AS that is already being used by one user.

The determiner 305 makes the first way of determination upon receipt of, from the terminal device 10a, request information together with an order to rent a vehicle V. The determiner 305 makes the second way of determination upon receipt of, from the terminal device 10b, request information indicating a wish to enter the sound space AS of a vehicle V that is already being used by one user.

In a case that the determiner 305 makes the first way of determination, the determiner 305 refers to the sound condition included in the request information transmitted from the terminal device 10a and the equipment specification of an available audio equipment AE as included in the status information, which is obtained by the first obtainer 301. Then, in a case that there is an available vehicle V equipped with an audio equipment AE whose equipment specification corresponds to the sound condition included in the request information, the determiner 305 allows the user to use the sound space AS. The determiner 305 may determine whether to allow usage of the sound space AS based on other than the equipment specification. For example, the determiner 305 may determine whether to allow usage of the sound space AS based on availability status of the vehicle V (such as a short waiting time or no waiting time). For another example, the determiner 305 may determine whether to allow usage of the sound space AS based on arrival time estimated based on traffic conditions and the distance from the current location of the vehicle V to the user's location. Another possible example is that the determiner 305 transmits the equipment specification, the availability status, or the arrival time to the terminal device 10a and allow the user of the terminal device 10a to use the sound space AS upon receipt of, from the terminal device 10a, an agreement to enter the sound space AS.

In a case that the determiner 305 makes the second way of determination, the second obtainer 304 obtains specifying information specifying the boarding aspirant who has been allowed to use the sound space AS. In a case that the second obtainer 304 has obtained the specifying information, the determiner 305 determines to allow the boarding aspirant to use the sound space AS. In the second way of determination, the determiner 305 allows another user to use the sound space AS upon receipt of an agreement from the terminal device 10a of the user who is already on board.

The first transmitter 306 transmits the request information to the user's terminal device 10a.

For example, it will be assumed that a boarding aspirant is carrying the terminal device 10b and the user who is already aboard the vehicle Vis carrying the terminal device 10a. In this case, the first transmitter 306 receives request information indicating a wish for entrance from the terminal device 10b of the boarding aspirant. Upon receipt of the request information, the first transmitter 306 transmits the request information including the evaluation value of the boarding aspirant to the terminal device 10a of the user who is already aboard the vehicle V.

The first transmitter 306 also transmits candidate data of an available vehicle V candidate to the terminal device 10a. The candidate data includes the equipment specification, the availability status, the arrival time of the vehicle V candidate to the user's location, and the usage fee. A user who wishes to rent a vehicle Vis able to consider whether to rent the vehicle V candidate based on its candidate data.

The first transmitter 306 also transmits the evaluation values of dispatched members to the terminal device 10a of a user who wishes to rent the vehicle V. This ensures that the user who wishes to rent the vehicle Vis able to refer to the evaluation values of the dispatched members to select a dispatched member to be actually dispatched, from among the dispatched members.

The evaluation obtainer 307 obtains an evaluation value of the dispatched member from the terminal device 10 (the terminal device 10a or the terminal device 10b) of the user with which the dispatched member shared the performance space.

The fee calculator 308 calculates a usage fee for using the sound space AS based on the evaluation value of the dispatched member. For example, the fee calculator 308 may calculate a higher fee as the evaluation value of the dispatched member is higher. For another example, the fee calculator 308 may calculate the usage fee by solving an equation that is based on the evaluation value and unit price (for example, an equation obtained by multiplying the evaluation value by the unit price). For another example, the fee calculator 308 may calculate the usage fee by: referring to data that indicates evaluation values linked to usage fees and that is stored in a memory in advance; and retrieving the usage fee corresponding to the evaluation value of the dispatched member. For another example, in calculating the usage fee, the fee calculator 308 may calculate a price per unit time based on the evaluation value of a target dispatched member group and regard this price per unit as the usage fee. Then, the fee calculator 308 may store the usage fee in the dispatched member storage 3022 as the usage fee for using the dispatched member group. In this case, every time the evaluation value of the dispatched member group is updated, the fee calculator 308 may calculate a usage fee based on the updated evaluation value and store the calculated usage fee in the dispatched member storage 3022.

The fee calculator 308 may also calculate a charged price based on information included in the user's request information requesting the rental of the vehicle V, and regard this charged price as the usage fee. The information includes the usage time and the unit price of the dispatched member group to be used.

The fee calculator 308 may also transmit, to a payment server device, a demand for payment processing based on the calculated usage fee. This ensures that the user is charged for using the vehicle V, so that the user pays the usage fee by the payment method stored in the user's user information.

The location obtainer 309 obtains the current location of the vehicle V. The location obtainer 309 may obtain the current location of the vehicle V from GNSS (Global Navigation Satellite Systems) incorporated in the vehicle V.

The map storage 310 stores map data of sound reduction levels linked to locations. Each of the sound reduction levels indicates a level by which the volume of sound in the sound space AS is reduced.

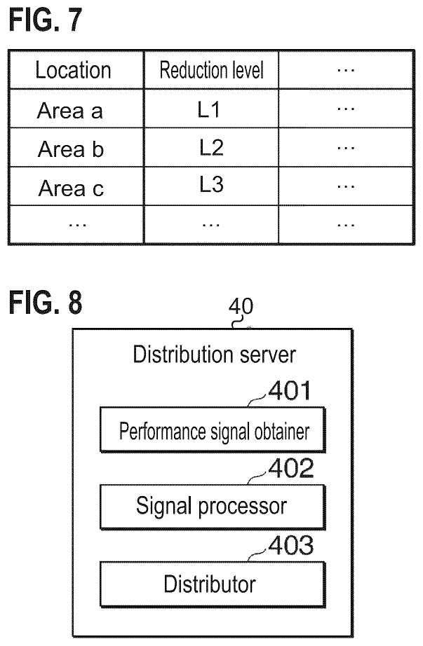

FIG. 7 is a schematic illustration of an example of the map data stored in the map storage 310.

The map data includes items Location and Sound reduction level. Location includes locations to which the vehicle V may possibly travel. For example, Location specifies the locations by areas such as “Area a”, “Area b”, and “Area c”.

Sound reduction level includes “Level L1”, “Level L2”, . . . “Level L4”. Sound reduction level may indicate that as the value of Sound reduction level is higher, the level by which to reduce the volume of sound is higher, or as the value of Sound reduction level is higher, the level by which to reduce the volume of sound is lower.

In FIG. 7, the location “Area a” is linked to the sound reduction level “Level L1”. This ensures that in a case that the current location of the vehicle Vis in “Area a”, the volume of the sound produced in the sound space AS is kept at the sound volume corresponding to “Level L1”. It is to be noted that the lower the level of sound reduction, the less the sound volume needs to be suppressed.

The outputter 311 retrieves, from the map storage 310, the sound reduction level corresponding to the location of the vehicle V, and outputs the retrieved sound reduction level to an external device. In a case that the external device is the audio equipment AE, the volume of the sound output from a speaker connected to the audio equipment AE can be set to the volume corresponding to the sound reduction level. In a case that the external device is the display M, the display M displays a message indicating that the volume of the sound output from a musical instrument should be set to the volume corresponding to the sound reduction level or a message advising to use a musical instrument that outputs a small volume of sound.

The vehicle exit information obtainer 312 obtains vehicle exit information from the terminal device 10 of the user. The vehicle exit information specifies an exit location at which the user exits the vehicle V.

The travel path adjuster 313 determines a travel path for the vehicle V based on the vehicle exit information. For example, the travel path adjuster 313 determines a travel path such that as the service end time approaches, the vehicle V stops at the specified exit location. In a case that a plurality of users exit at different exit locations, the travel path adjuster 313 determines a travel path such that the vehicle V stops at the exit locations in order. By determining the service end time in advance, the user is able to schedule automatic driving of the vehicle V to arrive at the user's home at the service end time.

In a case that the determination result of the determination made by the determiner 305 indicates that a user is allowed to enter the sound space AS of the vehicle V, the vehicle dispatching instructor 314 outputs an instruction to dispatch the vehicle V to the vehicle terminal 20. In this manner, the vehicle dispatching instructor 314 causes the vehicle V to be dispatched. Specifically, the vehicle terminal 20 causes the vehicle V to travel to the current location of the user or to a specified location. Thus, the vehicle V travels to pick up the user. In a case that the vehicle Vis a self-driving vehicle, the vehicle terminal 20 causes the vehicle V to travel by automatic driving to the location of the user to pick up the user. In a case that the vehicle Vis not a self-driving vehicle, the vehicle terminal 20 outputs the location to pick up the user as the destination of the vehicle V. This ensures that a driver drives the vehicle V to the destination to pick up the user.

FIG. 8 is a functional block diagram illustrating the functions of the distribution server 40.

The distribution server 40 includes a performance signal obtainer 401, a signal processor 402, and a distributor 403.

The performance signal obtainer 401 obtains a first performance signal and a second performance signal. The first performance signal is a performance signal of a piece of music played in the performance space. The second performance signal is a performance signal of a piece of music played in a place different from the performance space.

The signal processor 402 mixes the first performance signal and the second performance signal into a performance signal mixture.

The distributor 403 distributes the performance signal mixture (third performance signal) to a device. The device to which the third performance signal is distributed is at least one of the audio equipment AE provided in the performance space or the terminal device 10 of a user who performs in the place different from the performance space.

Next, operations of the vehicle dispatching system S will be described.

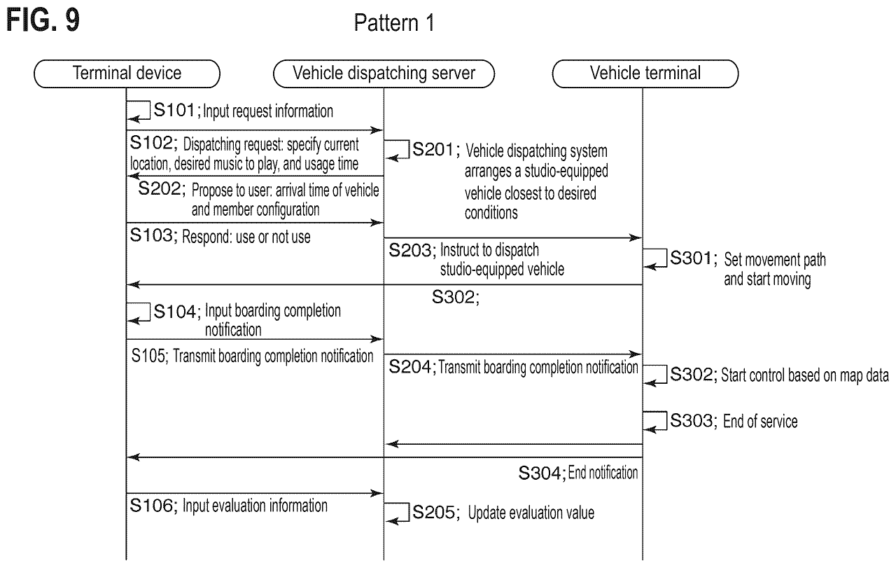

FIG. 9 is a flowchart describing operations of the vehicle dispatching system S.

The following description assumes a case that: the vehicle dispatching server 30 selects a vehicle V that accommodates the sound conditions desired by the user; and that the vehicle dispatching server 30 transmits information of the selected vehicle V to the terminal device 10a of the user to propose the vehicle V to the user.

### Step S101

The user U inputs request information into the terminal device 10a at any location such as home and workplace. For example, the user inputs, as request information, sound conditions including a piece of music that the user wishes to play, a musical instrument that the user wishes to play, and whether to request a dispatched member to be dispatched. The request information may also include the current location and the usage time.

### Step S102

Upon input of the request information from the user, the terminal device 10a transmits the request information to the vehicle dispatching server 30.

### Step S201

Upon receipt of the request information, the determiner 305 of the vehicle dispatching server 30 identifies a vehicle V that accommodates the sound conditions indicated by the request information. The determiner 305 identifies the vehicle V based on the received request information and the status information, which is obtained by the first obtainer 301. For example, the determiner 305 extracts a vehicle V that best satisfies the conditions indicated by the sound conditions, namely, the equipment specification, the availability status, and the arrival time of the vehicle V to the user's location. There may be a case that the request information includes an instruction for a request to dispatch a dispatched member as a sound condition. In this case, the determiner 305 identifies a dispatched member group the can board the vehicle V.

### Step S202

Based on the selected vehicle V, the first transmitter 306 of the vehicle dispatching server 30 transmits candidate data to the terminal device 10a. The candidate data includes information of the available vehicle V, including the equipment specification, the availability status, the arrival time of the vehicle V to the user's location, and the usage fee. In a case that a request for a dispatched member has been made, the first transmitter 306 transmits status information to the terminal device 10a based on the selected dispatched member. The status information includes, for example, the evaluation value of the dispatched member.

Upon receipt of the candidate data from the vehicle dispatching server 30, the terminal device 10a displays the received candidate data on the display screen of the terminal device 10a. When the candidate data is displayed on the display screen, the status information of the dispatched member is also displayed as part of the candidate data. The user U reviews the equipment specification and other information included in the candidate data displayed on the display screen to consider whether to use the selected vehicle V. In this example, the user is able to review the status information of the dispatched member as well. This enables the user to review the type of musical instrument that the dispatched member plays and the genre of music that the dispatched member plays before determining whether to use this dispatching service. If the user determines to use the dispatching service, the user inputs, into the terminal device 10a, an answer indicating the determination to use the dispatching service (step S103).

The terminal device 10a transmits the answer to the vehicle dispatching server 30 as answer data.

### Step S203

Upon receipt of the answer data from the terminal device 10a, the vehicle dispatching instructor 314 of the vehicle dispatching server 30 transmits the request information to the vehicle terminal 20 of a vehicle V that corresponds to the answer data. At the same time, the vehicle dispatching instructor 314 makes an instruction to dispatch the vehicle V. The vehicle dispatching server 30 retrieves the map data from the map storage 310 and transmits the map data to the vehicle terminal 20.

Then, the vehicle dispatching instructor 314 of the vehicle dispatching server 30 transmits a reservation notification to the terminal device 10c carried by the target dispatched member who is to be dispatched. At the same time, the vehicle dispatching instructor 314 transmits a vehicle dispatching instruction to the vehicle terminal 20 of the available vehicle V. Upon receipt of the reservation notification, the dispatched member boards the vehicle V.

The travel path adjuster 313 of the vehicle dispatching server 30 selects a travel path that extends from the departure location of the vehicle V (for example, a depot) to the pickup location to pick up the user (for example, the user's home) and, before the service usage time ends, returns to the endpoint while prioritizing areas with minimal external noise impact. While the travel path adjuster 313 selects the travel path, the vehicle terminal 20 may select the travel path in a case that the vehicle terminal 20 is provided with the functions of the travel path adjuster 313. The endpoint may be the user's home or any location specified by the user.

### Step S301

Upon receipt of the request information and the travel path, the vehicle terminal 20 sets a movement path and starts moving the vehicle V through the movement path so that the vehicle V arrives at the usage use start location before the usage start time.

In a case that the vehicle Vis a self-driving vehicle, the vehicle V starts traveling through the movement path that has been set toward the destination set to the current location of the user included in the request information. In a case that the vehicle V is not a self-driving vehicle, the driver drives the vehicle V toward the destination set to the current location of the user.

The vehicle terminal 20 obtains current location data indicating the current location of the vehicle V from ECU (Electronic Control Unit) of the vehicle V. Based on the current location data, the vehicle terminal 20 determines whether the vehicle V has come within a predetermined range centered around the destination (in this example, the user's home). In a case that the vehicle terminal 20 determines that the vehicle V has not come within the predetermined range centered around the destination, the vehicle terminal 20 again determines whether the vehicle V has come within the predetermined range after a predetermined period of waiting time passed.

### Step S302

Upon determining that the vehicle V has come within the predetermined range centered around the destination, the vehicle terminal 20 transmits notification data to the terminal device 10a's contact information included in the request information. The notification data indicates that the vehicle Vis arriving soon.

Upon receipt of the notification data on the terminal device 10a, the user is informed of the arrival of the vehicle V, and prepares for boarding the vehicle V, such as preparing a necessary musical instrument and equipment.

### Step S104

When the vehicle V arrives at the user's home, the user boards the vehicle V along with the musical instrument, and inputs a boarding completion notification into the terminal device 10a (step S105).

Upon receipt of the boarding completion notification from the user, the terminal device 10a transmits the boarding completion notification to the vehicle dispatching server 30 (step S204).

Upon receipt of the boarding completion notification from the terminal device 10a, the vehicle dispatching server 30 notifies the vehicle terminal 20 that the user is on board.

### Step S302

Upon receipt of the boarding completion notification from the vehicle dispatching server 30, the vehicle terminal 20 outputs an instruction to the vehicle V to travel through the movement path. The vehicle V travels through the movement path by automatic driving. The user U starts playing the musical instrument. In a case that a request for a dispatched member has been made, the dispatched member also enters the sound space AS. The user U, therefore, is able to play a session with the dispatched member. The vehicle terminal 20 transmits information indicating the current location of the vehicle V to the vehicle dispatching server 30 at regular intervals.

The outputter 311 of the vehicle dispatching server 30 refers to the map data stored in the map storage 310 to retrieve a sound reduction level corresponding to the area of the current location of the vehicle V. Then, the outputter 311 transmits the retrieved sound reduction level to the vehicle terminal 20. The vehicle terminal 20 outputs the received sound reduction level to the audio equipment AE. The audio equipment AE controls the volume of the sound output from the speaker SPa and the speaker SPb to the volume corresponding to the sound reduction level obtained from the vehicle terminal 20.

In this example, the information indicating the current location of the vehicle Vis transmitted to the vehicle dispatching server 30 at regular intervals. This ensures that if the moving destination of the vehicle Vis a residential area, the volume of the sound output from the speakers SPa and SPb can be controlled based on the sound reduction level. The vehicle terminal 20 may also display a message corresponding to the sound reduction level on the display M. For example, the vehicle terminal 20 may display a message: “Please reduce the sound volume in this area.” This enables the user to play the musical instrument at a low sound volume, or switch to a musical instrument that only outputs a low volume of sound. There may be a case that the user plays the drums or another musical instrument that is difficult to control the sound volume using an amplifier. In this case, a message may be displayed encouraging the user to play in a way that reduces the sound volume or to switch to electronic drums. A message may also be displayed encouraging the user to lower the amplifier volume. This ensures that, even if the sound from the vehicle V reaches outside while the vehicle Vis driving through residential areas or similar locations, the impact of the sound on the surroundings can be minimized. Additionally, since the vehicle Vis in motion, the position of the sound source continuously changes, preventing sustained noise from reaching surrounding residents.

Additionally, when the vehicle reaches an area where noise reduction is less necessary (for example, an area with few residential buildings), the vehicle terminal 20 increases the amplifier volume to a certain level. This enables the user to perform at an adequate volume in the sound space AS while minimizing the impact of sound on the outside of the vehicle V.

The vehicle V travels along the travel path. It is preferable for the travel path to avoid locations where changes in the vehicle V's posture are likely to occur, such as stops, right turns, left turns, sharp curves, and bumps. Minimizing changes in the vehicle V's posture reduces vehicle body sway, enabling the user to perform in the sound space AS with greater stability. Additionally, it is desirable for the travel path to minimize the impact of any sound that may escape from the vehicle V to the outside. The travel path may involve continuous movement or may include waypoints where the vehicle stops for a certain period of time. It is preferable for waypoints where the vehicle stops for a certain period to be areas where any sound that escapes from the vehicle V will have minimal impact (for example, a sparsely populated plaza).

While the vehicle Vis traveling along the travel path, the travel path adjuster 313 may recalculate the travel path to avoid issues such as traffic congestion and road closures if such traffic information is obtained from an other server device.

As the service end time approaches, the vehicle V travels toward the endpoint. In this example, the vehicle V travels in such a way as to arrive at the endpoint by the service end time. Even while the vehicle Vis traveling toward the endpoint, the user is able to continue to play the musical instrument.

When the vehicle V approaches the endpoint and enters a residential area, the amplifier volume is lowered.

### Step S303

When the service end time arrives and the vehicle V arrives at the endpoint, the vehicle terminal 20 detects ending of the dispatching service (step S304).

Upon detection of the ending of the dispatching service, the vehicle terminal 20 transmits a service ending notification to the vehicle dispatching server 30 and the terminal device 10a. This concludes the dispatching service.

After the dispatching service, the vehicle V travels to the depot set as the destination, and returns to the depot.

### Step S106

The user U inputs an evaluation value of the dispatched member into the terminal device 10a.

The terminal device 10a transmits, to the vehicle dispatching server 30, the evaluation value of the dispatched member input from the user.

### Step S205

Upon receipt of the evaluation value of the dispatched member from the terminal device 10a, the vehicle dispatching server 30 updates the corresponding evaluation value in the dispatched member data.

In this embodiment, when the user rents a vehicle V, a dispatched member is already aboard the vehicle V. Another possible example is that the user rents a vehicle V without an onboard dispatched member. In this case, a single user is able to use the sound space AS. Another possible example is that the user summons, in advance, members whom the user wishes to play a session with, and at the time when the vehicle V arrives at the user's home, the summoned members and the user board the vehicle V to perform in the sound space AS. This enables the user to play a session with acquaintances using the vehicle V.

Next, other operations of the vehicle dispatching system S will be described.

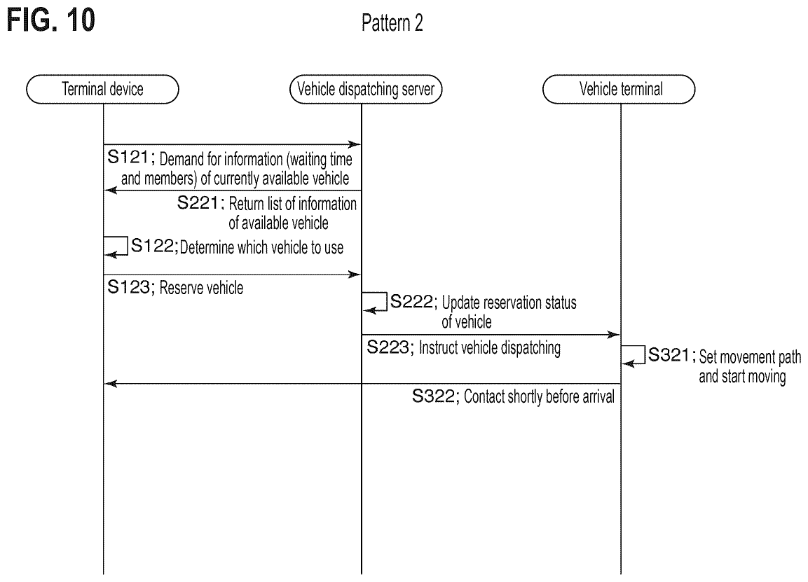

FIG. 10 is a flowchart describing other operations of the vehicle dispatching system S.

In the embodiment illustrated in FIG. 9, the vehicle dispatching server 30 extracts and proposes a vehicle V that potentially satisfies the needs of the user. In the embodiment illustrated in FIG. 10, the user selects a preferred vehicle V from among a plurality of candidates.

### Step S121

Upon input of an instruction from the user demanding information indicating currently available vehicles, the terminal device 10a transmits a demand for a list to the vehicle dispatching server 30 (step S221).

The vehicle dispatching server 30 generates a list by extracting data of available vehicles, and transmits the list to the terminal device 10a. Examples of the list include a list of the dispatched members illustrated in FIG. 6 and a list of the equipment specifications of the vehicles stored in the equipment storage 3023. By transmitting at least one of these lists, the user is shown the sound conditions (performance conditions) that each available vehicle V accommodates. The available vehicles are vehicles that can be rented immediately or vehicles that, while not immediately available, will become available after a waiting period.

In this example, in a case that there are a plurality of available vehicles, some of the plurality of available vehicles may be extracted.

The vehicle dispatching server 30 generates a list by extracting, for example, the dispatched member data illustrated in FIG. 6, and transmits the list to the terminal device 10a.

### Step S122

Upon receipt of the list from the vehicle dispatching server 30, the terminal device 10a displays the received list on the display screen. In this example, the dispatched member data illustrated in FIG. 6 is displayed on the display screen.

The user reviews the list displayed on the display screen and selects a vehicle V from the list. The terminal device 10a receives an input specifying a group ID from the dispatched member data. In this example, the user also inputs the usage time.

### Step S123

Upon receipt of the usage time and the specifying of the group ID, the terminal device 10a transmits, to the vehicle dispatching server 30, a vehicle reservation instruction along with the group ID and the usage time.

### Step S222

Upon receipt of the group ID and the vehicle reservation instruction, the vehicle dispatching server 30 updates a reservation status in the dispatched member data. For example, the vehicle dispatching server 30 adds, to the group ID, data indicating that the group ID is reserved.

### Step S223

The vehicle dispatching server 30 transmits a reservation notification to the terminal device 10c carried by the dispatched member identified by the group ID. At the same time, the vehicle dispatching server 30 transmits a vehicle dispatching instruction to the vehicle terminal 20 of the available vehicle V.

In this example, the vehicle dispatching server 30 refers to the user data of the user who has made the reservation, and notifies the vehicle terminal 20 that the user's location (home) is the pickup location, as well as notifying the usage time.

The reserved dispatched members board the reserved vehicle V until the waiting time ends.

### Step S321

Upon receipt of reservation details, the vehicle terminal 20 sets a movement path based on the user's location and the usage time. Upon ending of the waiting time, the vehicle terminal 20 causes the reserved vehicle V to start moving with the reserved dispatched members on board.

### Step S322

The vehicle terminal 20 obtains, from the ECU of the vehicle V, current location data indicating the current location of the vehicle V. Then, the vehicle terminal 20 determines whether the vehicle V has come within a predetermined range centered around the destination. Upon determining that the vehicle V has come within the predetermined range centered around the destination, the vehicle terminal 20 transmits notification data to the terminal device 10a of the user who has made the reservation. The notification data indicates that the vehicle Vis arriving soon.

The subsequent processing flow is the same as the processing flow at step S104 and onwards illustrated in FIG. 9, and therefore, the description of subsequent processing flow will be omitted.

This embodiment enables the user to freely select from the available vehicles according to the user's preference. For example, the user can make a selection by considering factors such as the waiting time, the rating of the dispatched members, the attributes of the dispatched members, and the usage fee.

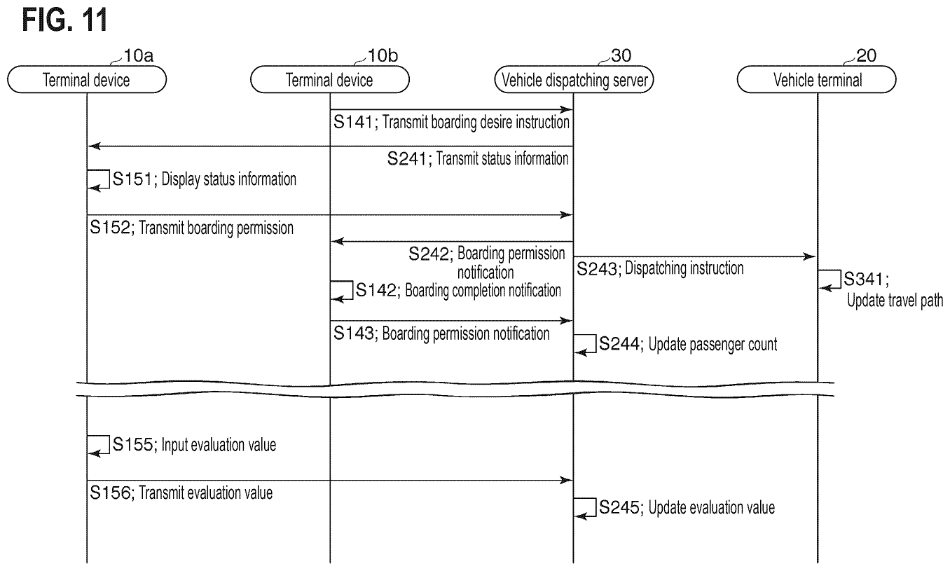

By referring to the flowchart illustrated in FIG. 11, description will be made with regard to a case that a user other than the user who requested the service for the vehicle Vis allowed to board the vehicle V.

In this example, a case that the vehicle Vis used along the flow illustrated in FIG. 9 or 10 will be described. Also in this example, a dispatched member may be or may not be aboard the vehicle V.

The vehicle V starts traveling with the user carrying the terminal device 10a on board. Upon start of the vehicle V, the vehicle dispatching server 30 makes the current location of the vehicle V accessible for reference by a terminal device. For example, the vehicle dispatching server 30 receives a request from at least one terminal device 10, among the plurality of terminal devices 10, that is carried by a user not aboard the vehicle V (for example, from the terminal device 10b). In response to the request, the vehicle dispatching server 30 transmits map data or a message to the terminal device 10b. The map data shows the location of the vehicle V on a map. The message describes the current location of the vehicle V. Along with the map data or the message, the vehicle dispatching server 30 transmits the status information of the vehicle V and information about the onboard user (such as the musical instrument that the onboard user plays and the onboard user's preferred genre). The transmitted map data may also show the travel path.

The user already aboard the vehicle V may pre-specify which other users are permitted to access the status information of the vehicle V and the information about the onboard user. The dispatch server 30 may make the information available only to the terminal devices of the pre-specified users, who are within a specified access range. The access range may include, for example, users who are friends, users attending the same school, and users working at the same workplace.

From the vehicle dispatching server 30, the terminal device 10b receives the map data, the status information of the vehicle V, and the information about the onboard user. Upon receipt of the information, the terminal device 10b displays the received information on the display screen of the terminal device 10b. The user of the terminal device 10b reviews the current location of the vehicle V, the status information of the vehicle V, and the information about the onboard user. In a case that the vehicle Vis traveling near the user of the terminal device 10b, the user of the terminal device 10b determines whether to perform with the onboard user based on the status information of the vehicle V, the onboard user's musical instrument, and the onboard user's preferred genre. In a case that the user of the terminal device 10b determines to perform with the onboard user, the user of the terminal device 10b inputs a boarding desire instruction into the terminal device 10b (step S141).

The terminal device 10b transmits the boarding desire instruction at a request from the user.

### Step S241

Upon receipt of the boarding desire instruction from the terminal device 10b, the vehicle dispatching server 30 retrieves the user information of the user of the terminal device 10b from the user storage 3021, and regards the user information as status information. Then, the vehicle dispatching server 30 transmits the status information to the terminal device 10a of the user who is renting the vehicle V that the user of the terminal device 10b wishes to board. In this manner, the vehicle dispatching server 30 notifies the terminal device 10a that there is a boarding aspirant who wishes to board the vehicle V.

### Step S151

Upon receipt of, from the vehicle dispatching server 30, the status information and the notification indicating that there is a boarding aspirant, the terminal device 10a displays, on the display screen, the notification indicating that there is a boarding aspirant, along with the received status information.

The user of the terminal device 10a reviews the status information displayed on the display screen, and determines whether to perform with the boarding aspirant. In a case that the user of the terminal device 10a determines to perform with the boarding aspirant, the user of the terminal device 10a inputs a boarding admission instruction into the terminal device 10a (step S151).

Upon input of the boarding admission instruction from the user of the terminal device 10a, the terminal device 10a transmits the boarding admission instruction to the vehicle dispatching server 30.

### Step S242

Upon receipt of the boarding admission instruction, the vehicle dispatching server 30 transmits a boarding admission notification to the terminal device 10b (step S243).

The vehicle dispatching server 30 also transmits a vehicle dispatching instruction to the vehicle terminal 20, along with information indicating the current location of the additional boarding user.

### Step S341

Upon receipt of the information indicating the current location of the additional boarding user, the vehicle terminal 20 updates the travel path to include the current location of the additional boarding user as a waypoint. This ensures that the vehicle V travels to the location of the user carrying the terminal device 10b.

Upon receipt of the boarding admission notification on the terminal device 10b, the user carrying the terminal device 10b prepares for boarding the vehicle V. Upon arrival of the vehicle V, the user carrying the terminal device 10b boards the vehicle V along with the musical instrument.

### Step S142

Then, the user carrying the terminal device 10a inputs a boarding completion notification into the terminal device 10b. The user carrying the terminal device 10a and the user carrying the terminal device 10b are able to play musical instruments in a session in the sound space AS (step S143).

Upon receipt of the boarding completion notification from the user carrying the terminal device 10b, the terminal device 10b transmits the boarding completion notification to the vehicle dispatching server 30.

Upon receipt of the boarding completion notification from the terminal device 10b, the vehicle dispatching server 30 updates passenger count by incrementing the passenger count. The fee calculator 308 may calculate the usage fee for each user based on the updated passenger count and notify each user's terminal device 10 (the terminal device 10a and the terminal device 10b) of the corresponding usage fee. The fee calculator 308 may determine the usage fee for each user by dividing the rental fee for the vehicle V by the number of users.

As the usage end time for the vehicle V approaches, the vehicle V transports the users to the users' homes by following a travel path that includes each home (step S155).

The user carrying the terminal device 10a inputs, into the terminal device 10a, an evaluation value of the user carrying the terminal device 10b (step S156).

The terminal device 10a transmits, to the vehicle dispatching server 30, the evaluation value input from the user carrying the terminal device 10a.

### Step S244

Upon receipt of the evaluation value of the dispatched member from the terminal device 10a, the vehicle dispatching server 30 updates the evaluation value in the dispatched member data.

In this embodiment, the user aboard the vehicle Vis able to determine whether to allow the boarding aspirant to board the vehicle V based on a profile of the boarding aspirant indicating the musical instrument and the genre played by the boarding aspirant. This enables the user aboard the vehicle V to more easily determine whether the user wants to perform with the boarding aspirant.

Also in this embodiment, the users who can access the current location of the vehicle V is limited to a range of people such as friends, users who are already acquainted, or users who share the same school or workplace. This enables the range of people to join in while the vehicle Vis traveling, even without a prior arrangement to perform together. As a result, users who are available at the time of a performance can participate, even without prior coordination of the schedule.

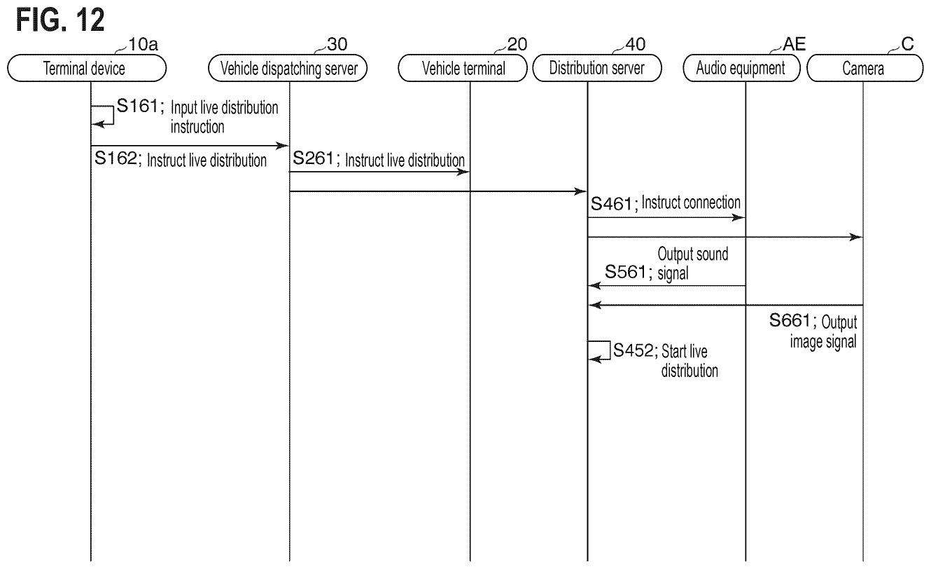

By referring to the flowchart illustrated in FIG. 12, description will be made with regard to a live distribution of the sound of the performance in the sound space AS.

In this example, a case that the usage of the vehicle V starts according to the flows illustrated in FIGS. 9 and 10 will be described. Also in this example, a dispatched member may be or may not be aboard the vehicle V. Also in this example, the processing of adding a member illustrated in FIG. 11 may be performed in advance or concurrently.

The vehicle V starts traveling with the user carrying the terminal device 10a on board. After the start of the vehicle V, the user carrying the terminal device 10a inputs a distribution instruction for a live distribution into the terminal device 10a (step S161).

The terminal device 10a receives the distribution instruction for a live distribution from the user of the terminal device 10a (step S162).

Upon receipt of the distribution instruction from the user of the terminal device 10a, the terminal device 10a transmits the distribution instruction to the vehicle dispatching server 30.

### Step S261

Upon receipt of the distribution instruction from the terminal device 10a, the vehicle dispatching server 30 transmits the distribution instruction to the vehicle terminal 20 and the distribution server 40.

Upon receipt of the distribution instruction, the vehicle terminal 20 may update the travel path to direct the vehicle V to a suitable location for stopping and performing. Performing while the vehicle Vis stationary makes the vehicle V less prone to shaking, allowing the user to live stream the user's performance in a more stable and conducive environment (step S461).

Upon receipt of the distribution instruction, the distribution server 40 outputs a connection instruction to the audio equipment AE and the camera C (step S561).

Upon receipt of the connection instruction from the distribution server 40, the audio equipment AE outputs, to the distribution server 40, a sound signal obtained from the microphone MC or the musical instrument G (step S661).

Upon receipt of the connection instruction from the distribution server 40, the camera C outputs, to the distribution server 40, an image signal of a captured image of the inside of the sound space AS.

### Step S452

The distribution server 40 distributes the sound signal obtained from the audio equipment AE and the image signal obtained from the camera C. For example, upon receipt of a distribution demand from the terminal device 10b of a user not aboard the vehicle V, the distribution server 40 distributes the image signal to the terminal device 10b. This enables the user of the terminal device 10b to view the sound and the image of the performance in the sound space AS of the vehicle V, even though the user of the terminal device 10b is not aboard the vehicle V.

In this embodiment, by renting the vehicle V, the user can also rent live distribution equipment. This enables the user to perform a live distribution even if the user does not own such equipment. Additionally, using the sound space AS minimizes the user's effort required to manage sound impact on the surrounding environment.

The distribution server 40 may also collect the sound produced in the sound space AS of the vehicle V and performance sound produced by a user located outside the vehicle V, and mix the sounds to distribute the sound mixture. In this example, the terminal device 10b collects the performance sound produced by the user located outside the vehicle V, generates a sound signal, and transmits the sound signal to the distribution server 40. This enables the distribution server 40 to collect the performance sound produced by the user located outside the vehicle V.

Thus, the performance signal resulting from the user located in the performance space of the vehicle V and the performance signal resulting from the user located outside the vehicle V are mixed and distributed to the users. This enables the user located inside the vehicle V and the user located outside the vehicle V to play the same piece of music.

In this embodiment, description was made for a session or a solo performance in the sound space AS. Another possible example is to use the sound space AS for different purposes. For example, a movement path is set with the departure point as the user's home and the destination as a performance venue. In a case that the performance venue is where the user gives the final performance, the user may first rehearse in the sound space AS while aboard the vehicle V, and then give the final performance upon arriving at the performance venue. This enables the user to rehearse during travel time, making more efficient use of time. Additionally, the user can proceed to the final performance immediately after the rehearsal, enabling the user to transition to the final performance while retaining the user's performance focus.

Performance venues include public facilities, event halls, and sports venues such as baseball stadiums, and also outdoor facilities. When an outdoor facility is used as the performance venue, the performer boards the vehicle V and conducts a rehearsal in the sound space AS during the travel to the outdoor facility. Upon arriving at the outdoor facility, walls of the sound space AS of the vehicle V can be unfolded to create a studio environment at the outdoor location. This eliminates the need to transport and set up studio equipment at the outdoor facility.

When the sound space AS is used as a music classroom, lessons can be conducted for instruments such as piano, guitar, and drums. For example, when a music classroom is used as an extracurricular activity for a child, the vehicle V can serve as the lesson venue. In this case, the vehicle V can travel to the child's home, pick up the child, and conduct the lesson while the child is onboard. The lesson can take place while the vehicle Vis in motion. The vehicle V is driven to ensure arrival at the child's home at the time when the lesson ends. This enables the child to exit the vehicle V near the child's home once the lesson is completed. As a result, there is no need to travel to a physical lesson venue for the music class. This ensures that the child's parents do not have to drive the child to and from the lesson, reducing the parents' burden.

When the sound space AS is used as a music classroom, the organizer of the music class does not need to arrange a building as the lesson venue. Therefore, even organizers who do not own a lesson venue can hold a music class by using the sound space AS of the vehicle V.

When the sound space AS is used as a music classroom, a teacher can be registered as a dispatched member along with a rating of the teacher. This enables users attending music classes to review ratings and consider which music class to attend. In this case, the lesson fee can be determined based on the rating.

In the embodiment described above, when performance conditions (such as an equipment specification and a dispatched member profile) are presented to a user, the user reviews the performance conditions and may make a boarding request. In response to the boarding request, a determination is made as to whether to allow the user to enter the performance space of the vehicle V. This enables the user to request boarding after reviewing the performance conditions, and if boarding is allowed, the user is able to perform in the performance space of the vehicle V. This reduces the effort and time required to travel to the desired sound space.

Also in the embodiment described above, a profile of a dispatched member or an additional member wishing to board the vehicle Vis presented to the user who is aboard the vehicle V. Upon review of the profile, the user determines whether to perform with the dispatched member or the additional member. This eliminates the need for the user to personally search for other members to perform with. This reduces the burden on the user of searching for members to perform with and coordinating schedules.

Also in the embodiment described above, an evaluation value of a dispatched member is received from a user who performed with the dispatched member, and the evaluation value is included in the status information and transmitted to the terminal device of This enables the another user to review the evaluation value of the dispatched another user. member and determine whether to request to perform with the dispatched member.

Also in the embodiment described above, the usage fee for the vehicle Vis determined based on the evaluation value of the vehicle V. This enables the operator of the vehicle V rental business to obtain fees from users in accordance with the evaluation value of the vehicle V. Additionally, the business operator can pay compensation to the dispatched members based on their evaluation values. The dispatched members receive compensation based on their evaluation values, increasing their motivation for activities at their assigned locations.

Also in the embodiment described above, the sound reduction level is output based on the current location of the vehicle V, allowing the external devices to adjust their control according to the sound reduction level.

Also in the embodiment described above, the vehicle V moves to the designated exit location, allowing the user to finish the performance and exit upon arrival at the desired exit location. This enables the user to be transported to the desired location. As a result, the burden on the user to personally manage travel after the performance is reduced.

For example, after work, the sound space of the vehicle V can be used with colleagues for a session, while the vehicle V transports each member to each member's home in sequence. This makes it possible to enjoy a session while making the most of travel time.

In the embodiment described above, the profile storage 302 and the map storage 310 are implemented using a storage medium such as HDD (Hard Disk Drive), flash memory, EEPROM (Electrically Erasable Programmable Read-Only Memory), RAM (Random Access Memory), ROM (Read-Only Memory), or any combination of these storage media. The profile storage 302 and the map storage 310 each may be, for example, a nonvolatile memory.

Also in the embodiment described above, the functions of the terminal device 10, the vehicle terminal 20, the vehicle dispatching server 30, and the distribution server 40 may be implemented by a processor such as CPU (Central Processing Unit) or by a dedicated electronic circuit.

In the embodiment described above, the vehicle dispatching system S includes the distribution server 40. In a case that a live distribution is not performed, the vehicle dispatching system S may not necessarily include the distribution server 40.

In the embodiment described above, the terminal device 10, the vehicle terminal 20, the vehicle dispatching server 30, and the distribution server 40 may be implemented by a computer. In this case, the program(s) for implementing the terminal device 10, the vehicle terminal 20, the vehicle dispatching server 30, and the distribution server 40 may be recorded in a computer readable storage medium, and the program recorded in the storage medium may be retrieved into a computer system and executed in the computer system. As used herein, the term “computer system” is intended to encompass hardware such as OS (Operating System) and peripheral piece of equipment. Also as used herein, the term “computer readable storage medium” is intended to mean: a transportable medium such as a flexible disk, a magneto-optical disk, a ROM (Read Only Memory), a CD-ROM (Compact Disk Read Only Memory); and a storage device such as a hard disk incorporated in a computer system. Also as used herein, the term “computer readable storage medium” is intended to encompass: a medium that dynamically holds a program for a short period of time, a non-limiting example being a communications line through which a program is transmitted using a network such as the Internet or a telephone line; and a memory that holds a program for a predetermined period of time, a non-limiting example being a volatile memory built in a computer system serving as a client or a server in cases where a communications line is used as described above. It is also to be noted that the above-described program may be used to implement part of the above-described functions. It is further to be noted that the above-described program may be used to implement the above-described functions in combination with a program already recorded in the computer system. It is further to be noted that the above-described program may be implemented using a programmable logic device such as an FPGA (Field-Programmable Gate Array).

For example, the functions of the terminal device 10 may be implemented by installing and executing a program on a smartphone, a tablet, or any other terminal device to cause the terminal device to perform information processing according to the functions of terminal device 10. In this case, the computer-implemented information processing may include: obtaining vehicle information from a dispatching device, the vehicle information including a profile of a passenger who boards a vehicle including a performance space and who uses the performance space; performing a first processing of displaying the pieces of vehicle information on a display device; receiving an input from the user specifying a vehicle corresponding to a piece of the vehicle information among a plurality of the vehicle information; transmitting the vehicle information corresponding to the specified vehicle to the dispatching device; and performing processing of receiving, the dispatching device, confirmation as to whether the vehicle specified by the vehicle information is available.

The vehicle information may include the current location of the traveling vehicle V or a planned travel path, and the first processing may include displaying the current location or the planned travel path on the display device.

In this embodiment, a user is able to review a profile of the passenger who is using each performance space of each vehicle. Upon review of the profile, the user is able to specify which vehicle to use, and board the specified vehicle.

This enables the user to evaluate, based on the profile of the member, whether the member is suitable for performing together in the performance space. Upon determining that the member is suitable, the user is able to board the vehicle and participate in the performance.

Additionally, the user is able to evaluate whether the vehicle is located at a place where boarding is possible by using the current location or the planned travel path as a reference, and then decide whether to board the vehicle.

The embodiments reduce the time and effort required to move to a desired sound space.

While embodiments of the present disclosure have been described in detail by referring to the accompanying drawings, the embodiments described above are not intended as limiting specific configurations of the present disclosure, and various other designs are possible without departing from the scope of the present disclosure.

What is claimed is:

1. A vehicle dispatching system comprising:
a first obtainer configured to obtain status information including a sound condition employed in a sound space provided in a vehicle;
a second obtainer configured to obtain request information transmitted from a terminal device of a first user, the request information including a desired sound condition that the first user wishes to be realized in the sound space in the vehicle;
a determiner configured to make a determination, based on the status information and the request information, as to whether to allow the first user to board the vehicle; and
a vehicle dispatching instructor configured to dispatch the vehicle based on a result of the determination made by the determiner.

2. The vehicle dispatching system according to claim 1, further comprising a first transmitter configured to transmit the status information to the terminal device of the first user,
wherein the request information indicates that the first user wishes to board the vehicle.

3. The vehicle dispatching system according to claim 2, further comprising:
an evaluation obtainer configured to obtain an evaluation of each of a plurality of other users who used the sound space together with the first user; and
an evaluation storage configured to store the obtained evaluation of each of the plurality of other users,
wherein the first transmitter is configured to transmit the status information such that the status information includes the evaluation.

4. The vehicle dispatching system according to claim 1, wherein
the sound space is a performance space,
the sound condition is a performance condition in the performance space, and
the request information indicates the performance condition.

5. The vehicle dispatching system according to claim 4, wherein the status information includes a profile of a dispatched member who performs in the performance space and who is dispatched along with rental of the vehicle.

6. The vehicle dispatching system according to claim 5, further comprising:
an evaluation obtainer configured to obtain an evaluation of the dispatched member from the first user after using the performance space together with the dispatched member; and
an evaluation storage configured to store the evaluation of the dispatched member for each user who used the performance space together with the dispatched member,
wherein the status information includes the evaluation of the dispatched member.

7. The vehicle dispatching system according to claim 6, further comprising a fee calculator configured to obtain a usage fee for using the sound space based on the evaluation.

8. The vehicle dispatching system according to claim 4, further comprising:
a performance signal obtainer configured to obtain:
a first performance signal that is a performance signal of a piece of music played in the performance space; and
a second performance signal that is a performance signal of the piece of music played in a different place different from the performance space;
a signal processor configured to mix the first performance signal and the second performance signal into a performance signal mixture; and
a distributor configured to distribute the performance signal mixture to:
an output device that outputs sound in the performance space; and
a terminal device of a different-place user who performs in the different place.

9. The vehicle dispatching system according to claim 1, wherein the status information includes information indicating a piece of equipment available in the sound space.

10. The vehicle dispatching system according to claim 1, wherein
the status information includes profiles of boarding aspirants wishing to board the vehicle and ready to board the vehicle,
the second obtainer is configured to obtain, from a terminal device of an onboard user in the vehicle, specifying of a boarding aspirant, among the boarding aspirants, to be allowed to board the vehicle, and
the determiner is configured to determine to allow the boarding aspirant to board the vehicle.

11. The vehicle dispatching system according to claim 1, further comprising:
a location obtainer configured to obtain information indicating a current location of the vehicle;
a map storage configured to store sound reduction levels linked to locations, the sound reduction levels each indicating a level by which a volume of sound in the sound space is reduced; and
an outputter configured to:
from the map storage, retrieve a sound reduction level, among the sound reduction levels, that corresponds to the current location of the vehicle; and
output the retrieved sound reduction level to an external device.

12. The vehicle dispatching system according to claim 1, further comprising:
a vehicle exit information obtainer configured to obtain vehicle exit information from the terminal device of the first user, the vehicle exit information specifying a location of the vehicle at which the first user exits the vehicle; and
a travel path adjuster configured to determine a travel path of the vehicle based on the vehicle exit information.

13. A computer-implemented method of processing information, the method comprising:
obtaining status information including a sound condition employed in a sound space provided in a vehicle;
obtaining request information transmitted from a terminal device of a user, the request information indicating a desired sound condition that the user wishes to be realized in the sound space in the vehicle;
based on the status information and the request information, making a determination as to whether to allow the user to board the vehicle; and
dispatching the vehicle based on a result of the determination.

14. A computer-implemented method of processing information, the method comprising:
obtaining, from a vehicle dispatcher, pieces of vehicle information each including a profile of a passenger who boards a vehicle including a performance space and who uses the performance space;
performing first processing of displaying the pieces of vehicle information on a display;
obtaining an instruction specifying a vehicle to be used from a user selecting a piece of vehicle information from among the pieces of vehicle information;
transmitting, to the vehicle dispatcher, specifying information corresponding to the obtained instruction; and
from the vehicle dispatcher, receiving information indicating whether the vehicle specified by the specifying information is available.

15. The method according to claim 14, wherein
the vehicle information includes information indicating a current location at which the vehicle is currently traveling or a prospected travel path of the vehicle, and
the first processing includes displaying the current location or the prospected travel path on the display.

16. A non-transitory computer-readable storage medium storing a program which, when executed by at least one processor, causes the at least one processor to:
obtain, from a vehicle dispatcher, pieces of vehicle information each including a profile of a passenger who boards a vehicle including a performance space and who uses the performance space;
perform first processing of displaying the pieces of vehicle information on a display;
obtain an instruction specifying a vehicle to be used from a user selecting a piece of vehicle information from among the pieces of vehicle information;
transmit, to the vehicle dispatcher, specifying information corresponding to the obtained instruction; and
from the vehicle dispatcher, receive information indicating whether the vehicle specified by the specifying information is available.
